(19) United States
(12) Patent Application Publication
(10) Pub. No.: US 2023/0129037 A1
(43) Pub. Date: Apr. 27, 2023

(54) BOARD MANAGEMENT CONTROLLER AND METHOD FOR STARTING THEREOF

(71) Applicant: Xunmu Information Technology (Shanghai) Co., Ltd., Shanghai (CN)

(72) Inventor: Jiang WANG, Shanghai (CN)

(73) Assignee: Xunmu Information Technology (Shanghai) Co., Ltd., Shanghai (CN)

(21) Appl. No.: 17/689,308

(22) Filed: Mar. 8, 2022

(30) Foreign Application Priority Data
Oct. 26, 2021 (CN) 202111245266.9

(51) Int. Cl. G06F 9/4401; G06F 9/445; G06F 11/14; G06F 11/07

(52) U.S. Cl. CPC G06F 9/4406; G06F 9/44505; G06F 9/44536; G06F 11/1417; G06F 11/0772

(57) ABSTRACT

An improved board management controller provides a stable operating environment. The board management controller comprises a flash memory device and a microprocessor. The flash memory device is partitioned into a boot area, a first partition and a second partition in advance. The boot area stores a bootup firmware, the first partition is formatted as a first file system, the second partition is formatted as a second file system, and the first operating system image file and the first software application are stored in the first file system. The second operating system image file and the second software application are stored in the second file system. Multiple advantages are provided by the board management controller, comprising flexible space configuration, the ability to recover from damaged faults, and high data reliability. The efficiency of the operation has also been improved to speed up the startup of the board management controller.

### CROSS REFERENCE TO RELATED APPLICATION

This application claims the priority benefit of Chinese Patent Application Serial Number 202111245266.9, filed on Oct. 26, 2021, the full disclosure of which is incorporated herein by reference.

### BACKGROUND

### Technical Field

The application relates to a management controller of a computer system, in particular, to an improved board management controller adaptable for computer servers or high-end switches, which features faster startup speed and higher reliability.

### Related Art

A board management controller (BMC) is mainly used in computer systems such as servers or high-end switches. A BMC is responsible for the most fundamental functions of the system, such as hardware status management, operating system management, health status management and power consumption management.

Therefore, the startup speed and reliability of a board management controller are critical. If the startup of a board management controller is delayed, the startup time of the whole system is also affected. In the case that a board management controller is unstable, the stability of the whole system is consequently affected.

FIG. 1 is an architecture diagram of a conventional computer system 100 and a board management controller 120. The computer system 100 comprises the board management controller 120. The board management controller 120 comprises at least a microprocessor 122, a memory device 124, and a flash memory device 130. The board management controller 120 itself is an embedded processor. Software executed by the microprocessor 122 may include a bootup firmware 132, an operating system 134 (i.e., Linux). Various software applications commonly used by the board management controller 120 are generally stored in the file system 136.

As shown in FIG. 1, the said bootup firmware 132, the operating system 134, and the file system 136 are located in the flash memory device 130. A start area of the flash memory device 130 stores the bootup firmware 132. The bootup firmware 132 may comprise U-boot, a commonly used system, which occupies about 0.5 mega-bytes (MB). Next, an image file of the operating system 134 is stored in a subsequent space after the bootup firmware 132. The image file of the operating system 134 may be a Linux core image, sizing several megabytes (MB), such as 2 to 5 MB. The remaining portion of the flash memory device 130 may be formatted as a file system for storing the software application of the board management controller. At present, the most widely used file system is the Journaling Flash File System (JFFS).

FIG. 2 is a flowchart to start a conventional board management controller 120. In step 201, the board management controller 120 is powered on. In step 203, the bootup firmware 132 is read from the flash memory device 130 to be executed. After the board management controller 120 is powered on or restarted, the microprocessor 122 in the board management controller 120 first reads the bootup firmware 132 from the flash memory device 130. In step 205, after executing the bootup firmware 132, the microprocessor 122 loads the operating system 134 from the flash memory device 130 according to a preconfigured boot address to start the operating system 134. In step 207, after executing the operating system 134, a file system driver embedded in the operating system 134 is executed by the microprocessor 122 to mount a preformatted file system 136 in the flash memory device 130 as a logical hard disk. Thereafter, in step 209, the board management controller 120 loads and executes a software application from the successfully mounted file system 136.

The arrangements and startup procedures of the conventional flash memory device have several disadvantages.

The arrangements and startup procedures of the conventional flash memory device are not flexible. The area storing the operating system 134 is fixed in address and length. If the reserved space is too large, it is waste of space. On the other hand, if the reserved space is too small, when the operating system 134 to be updated in the future exceeds the reserved space, the layout of the whole flash memory device 130 needs to be changed, which is complex and time-consuming.

The arrangements and startup procedures of the conventional flash memory device are unreliable. The operating system 134 and the file system 136 do not have a backup mechanism. Once there the update is failed and accidentally damages the file system 136, the board management controller 120 cannot be started, resulting in function failures in the computer system 100.

The arrangements and startup procedures of the conventional flash memory device are inefficient. The performance of JFFS may deteriorate as the flash memory device is increased in capacity.

### SUMMARY

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

To solve the aforementioned technical problems, the embodiment of the present application provides an improved board management controller to render a more stable operating environment. The board management controller comprises a flash memory device and a microprocessor. The flash memory device is partitioned into a boot area, a first partition and a second partition. The boot area stores bootup firmware, the first partition is formatted as a first file system, the second partition is formatted as a second file system, and the first operating system image file and the first software application are stored in the first file system, and the second operating system image file and the second software application are stored in the second file system.

When the board management controller is powered on, the microprocessor loads and executes the bootup firmware from the boot area. The microprocessor may selectively mount the first file system or the second file system according to a pre-determined configuration profile. Upon successful mounting, a corresponding operating system image file and software application are loaded and executed from the mounted file system to control the computer system.

In a further embodiment, the first operating system image file may include a factory default operating system, and the second operating system image file may include a product version operating system. In this case, the factory default operating system usually comprises only basic functions, while the product version operating system may include a variety of additional functions, so the configured capacity of the second file system may be configured to be greater than that of the first file system. In addition, the factory default operating system is usually used as a backup system, and the integrity thereof must be maintained as much as possible. Therefore, when the first file system is mounted, it is preferably mounted in a read-only mode. The product version operating system may allow frequent updates, so when the second file system is mounted, it is mounted in a read-write mode.

In a further embodiment, the first partition and the second partition may be identical and serving as backups to each other. In this case, the first operating system image file and the second operating system image file are of the same version, and the capacity of the second file system is the same as that of the first file system. Both may be mounted in read-write mode.

In a further embodiment, the first file system or the second file system is a Journaling Flash File System (JFFS). On the other hand, the first file system or the second file system may also be an Unsorted Block Image File System (UBIFS).

In a further embodiment, when the microprocessor mounts the first file system or the second file system, if it is found that the file system being mounted is damaged, the microprocessor may turn to mount another undamaged file system. After another file system is modified and started successfully, a recovery program may be executed to fix the damaged file system.

The application also proposes an embodiment of a computer system, comprising the board management controller as discussed above, and the computer system is controlled by the board management controller to perform at least one of the following functions: startup, shutdown, reset, system firmware upgrade, and operation data monitoring.

The application also proposes an embodiment of a board management controller startup method based on the architecture of the board management controller. Firstly, when the board management controller is powered on, the bootup firmware is loaded from the boot area to be executed. Thereafter, the first file system or the second file system is selectively mounted according to a predetermined configuration profile. Finally, the corresponding operating system image file and software application are loaded from the mounted file system to execute the function of controlling the computer system.

Compared with the currently known flash memory device layout and startup scheme in the board management controller, the proposed embodiments feature multiple obvious advantages.

The board management controller flash memory device of the application has strong flexibility in layout arrangements. In the conventional flash memory device 130, the address offset and size are predetermined. In the embodiment, the operating system is stored as an image file in a file system of the flash memory device 400, rather than raw data in a fixed partition. The design may not only save space in the flash memory device, but also accommodate files with varying sizes.

The board management controller flash memory device layout of the application has high reliability. The flash memory device is partitioned into two partitions to serve as the file systems. Once a partition is accidentally damaged due to update failure and/or other reasons, another partition may be used to start the board management controller or recover the damaged partition.

The performance of the board management controller adapting the proposed flash memory device layout is improved. The UBIFS has good scalability for flash memory device size, loading time, and memory consumption. The access speed is independent on the partition size, and its performance is significantly better than the JFFS. Adapting the UBIFS in the flash memory device may speed up the startup of board management controller.

The two partitions used to store the file system in the flash memory device may be of equal size, and the stored contents and read-write attributes may also be adjusted according to the actual situation. For example, both partitions may store the same product version operating system in read-write mode, serving as backups to each other.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is an architecture diagram of a conventional computer system 100 and a board management controller 120.

FIG. 2 is a flowchart of starting up a conventional board management controller 120.

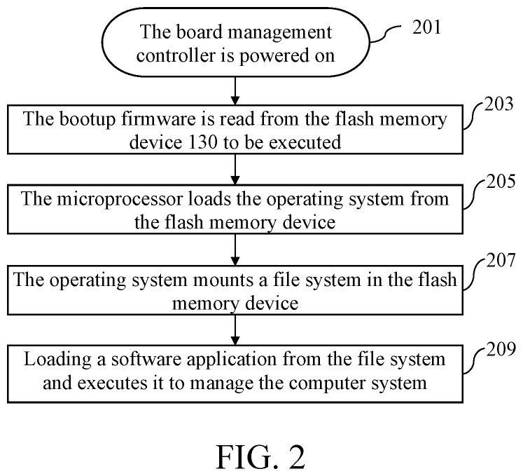

FIG. 3 is an architecture diagram of a computer system 300 and a board management controller 310 according to an embodiment of the application.

FIG. 4 is an architecture diagram of a flash memory device 400 in the board management controller 310 according to an embodiment of the application.

FIG. 5 is a flowchart of starting up the board management controller 310 according to the embodiment of the application.

### DETAILED DESCRIPTION OF THE EMBODIMENTS

The present invention will now be described more fully hereinafter with reference to the accompanying drawings, in which exemplary embodiments of the invention are shown. This present invention may, however, be embodied in many different forms and should not be construed as limited to the embodiments set forth herein. Rather, these embodiments are provided so that this present invention will be thorough and complete, and will fully convey the scope of the present invention to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the invention. This description is made for the purpose of illustration of the general principles of the invention and should not be taken in a limiting sense. The scope of the invention is best determined by reference to the appended claims.

Moreover, the terms “include”, “contain”, and any variation thereof are intended to cover a non-exclusive inclusion. Therefore, a process, method, object, or device that comprises a series of elements not only include these elements, but also comprises other elements not specified expressly, or may include inherent elements of the process, method, object, or device. If no more limitations are made, an element limited by “include a/an . . . ” does not exclude other same elements existing in the process, the method, the article, or the device which comprises the element.

In the following embodiment, the same reference numerals are used to refer to the same or similar elements throughout the invention.

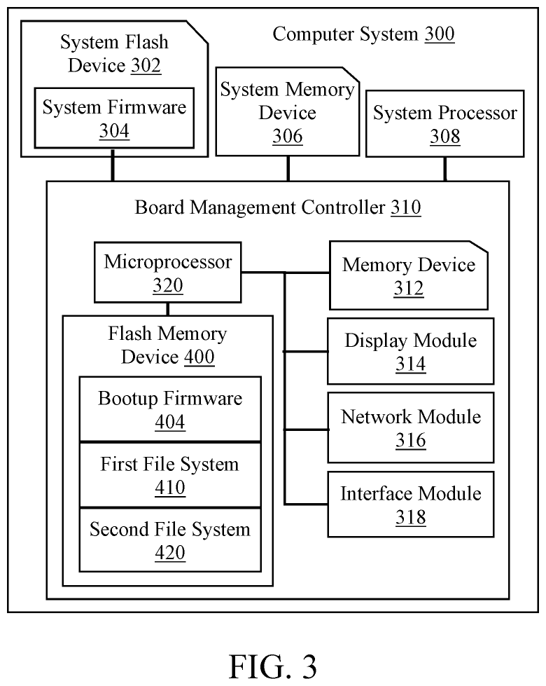

FIG. 3 is an architecture diagram of a computer system 300 and a board management controller 310 according to an embodiment of the application. The computer system 300 is mainly composed of a main board (or substrate), which at least comprises a system flash memory device 302, a system memory device 306, and a system processor 308. The system flash memory device 302 stores a system firmware 304 for the system processor 308 to load and start the computer system 300. The system memory device 306 is used to store data required for operating the computer system 300. Further implementation details are not introduced herein. The computer system 300 also comprises the board management controller 310 proposed in the application. The board management controller 310 may control the computer system 300 to perform at least one of the following functions: startup, shutdown, reset, system firmware upgrade, and operation data monitoring.

The board management controller 310 is a basic control unit in the computer system 300, adaptable to manage and connect various modules and components of different functions within the computer system 300. For example, the board management controller 310 may be connected to the system processor 308 through a Peripheral Component Interface-Express (PCI-E) bus and a Low Pin Count (LPC) bus, to the system memory device 306 through a Double Data Rate (DDR) bus, and to the system flash memory device 302 through a Serial Peripheral Interface (SPI) bus. Thus, the components on the computer system 300 may operate smoothly through the management of the board management controller. In addition, the board management controller 310 may also collect operation data from various components and serial hardware of the computer system 300. If an abnormal condition is detected, the board management controller 310 may automatically send a warning message to the operation and maintenance personnel, and the operation and maintenance personnel may carry out remote diagnosis and troubleshooting according to the information provided by the computer system 300.

The board management controller 310 comprises at least a microprocessor 320 and a flash memory device 400, and may further include a memory device 312, a display module 314, a network module 316, and an interface module 318. The memory device 312 is used to store data required for the operation of the microprocessor 320. The display module 314 may provide external display interfaces independent of the computer system 300, such as D-sub, DVI, HDMI, etc., so that the on-site maintenance personnel may read a terminal display of the board management controller 310. The network module 316 provides a network interface independent of the computer system 300, such as RJ-45 or Reduced Gigabit Media-Independent Interface (RGMII), so that a maintenance personnel may remotely control the board management controller 310. The interface module 318 may provide a serial interface independent of the computer system 300, such as a Universal Serial Bus (USB) or a serial port, for the maintenance personnel to connect the keyboard and mouse in series on site to operate the system.

The flash memory device 400 of the embodiment is specially partitioned in advance to contain a bootup firmware 404, a first file system 410, and a second file system 420. The operating systems are stored in the first file system 410 and the second file system 420 in the forms of image files, allowing the board management controller 310 to load and execute after powering on. Such an arrangement is advantageous for that the first file system 410 and the second file system 420 may store not only the operating system, but also the software application. That is, the space configuration has great flexibility. The flash memory device 400 does not need to particularly rearrange the partition sizes based on the operating system. The microprocessor 320 may be connected to the flash memory device 400 through the SPI bus. When the board management controller 310 is powered on, the microprocessor 320 may first load and execute the bootup firmware 404 from the beginning address of the flash memory device 400. The bootup firmware 404 may be improved to include a driver and a configuration profile for the file system, allowing the microprocessor 320 to accordingly mount and access the first file system 410 and/or the second file system 420. According to the configuration profile, the microprocessor 320 may selectively mount one of the first file system 410 and the second file system 420 as a logical hard disk for operation. After the mount is successful, the microprocessor 320 loads and executes the corresponding operating system image file and software application from the mounted file system to realize the functions of controlling the computer system.

In a particular embodiment, the area in the flash memory device 400 other than the bootup firmware 404 may be partitioned into a first partition 412 and a second partition 422 using the technology specified in the Memory Technology Device (MTD) utility. Thereafter, the first file system 410 and the second file system 420 are created in the corresponding first partition 412 and the second partition 422 by formatting tools, such as UBI tools. Another possible approach is to arrange the spaces in the flash memory device 400 except bootup firmware 404 into an MTD partition, and then cut the MTD partition into different UBI containers (volumes) based on the sizes of the first file system 410 and the second file system 420. The advantage of using UBI container is that the size between two partitions can be flexibly adjusted.

In a further embodiment, the configuration profile for selecting the first file system 410 and the second file system 420 may be a factory predetermined value or a value adjustable on demand. For example, when one of the first file system 410 and the second file system 420 is damaged, or the operating system is crashed by a failed upgrade procedure, the board management controller 310 may determine to start from another normal file system to maintain basic functions and even further implement the self-healing functions.

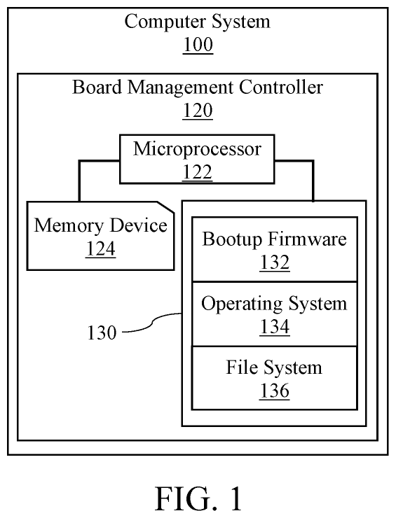

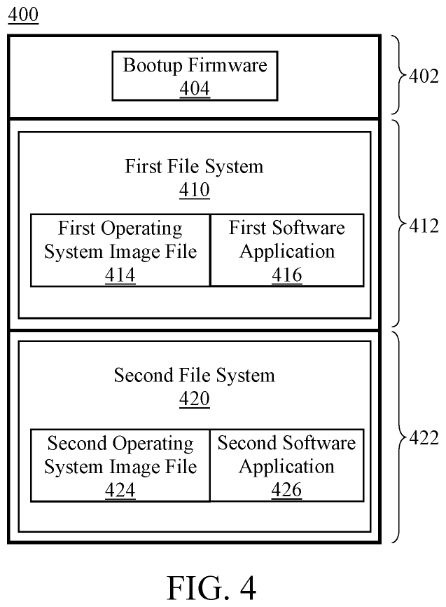

FIG. 4 is an architecture diagram of a flash memory device 400 in the board management controller 310 according to an embodiment of the application. The embodiment is specifically designed to withdraw the use of a partition that stores the operating system 134 as shown in FIG. 1. The whole space of the flash memory device 400 is partitioned into three partitions, a boot area 402, a first partition 412, and a second partition 422. The boot area 402 stores a bootup firmware 404. The boot area 402 is located at the foremost portion of the flash memory device 400 and contains the address 0. After the board management controller 310 is powered on or restarted, by design, the bootup firmware 404 in the boot area 402 will be actively read and executed. The first partition 412 and the second partition 422 are respectively formatted as a first file system 410 and a second file system 420, each configured with the same or different sizes. The first file system 410 may be used to store a first operating system image file 414 comprising a factory default operating system. Since the factory default operating system usually contains only basic functions, less space is required, such as 20 MB. The second file system 420 may be used to store a second operating system image file 424 comprising a product version operating system. Generally, the product version operating system is embedded with a second software applications 426 for various functions such as upgrading or error recovery. Therefore, more space is required, such as 43.5 MB. If the first file system 410 and the second file system 420 are formatted by some advanced file system technologies, the capacity allocation of the partitions may support flexible adjustments whenever necessary.

For example, the first file system 410 and the second file system 420 may be formatted to be the UBIFS. The overall performance of the UBIFS is better than the JFFS, and the access speed will not be deteriorated with the increase of flash memory device capacity. In practice, the attributes of the contents in the first file system 410 are in a read-only mode, and the attributes of the contents in the second file system 420 may be in a read-write mode to allow file upgrading. After a predetermined configuration, the board management controller 310 may preferentially load the second operating system image file 424 from the second file system 420 after startup. If any fault occurred to the second file system 420, such as failing to mount, found file system errors, or failing to start after upgrading, the logic program in the bootup firmware 404 may instruct the microprocessor 320 to mount the first file system 410 and load the first operating system image file 414 therefrom, allowing the board management controller 310 to be started. The first file system 410 may further comprise a first software application 416. After the first operating system image file 414 is loaded and executed, the board management controller 310 may execute the first software application 416. For example, the first software application 416 may include a recovery program that can fix the second file system 420 or reinstall the second operating system image file 424.

In other words, the flash memory device 400 of the embodiment is partitioned into a boot area 402, a first partition 412, and a second partition 422. The bootup firmware 404 is stored in the boot area 402, the first partition 412 is formatted to be the first file system 410, and the second partition 422 is formatted to be the second file system 420. The first file system 410 stores a first operating system image file 414 and one or more first software applications 416. The second file system 420 stores a second operating system image file 424 and one or more second software applications 426.

In a further embodiment, the first operating system image file 414 may include a factory default operating system, and the second operating system image file 424 may include a product version operating system. In this case, the first software application 416 in the factory default operating system provides only basic functions, such as a tool program for recovering the file system or restoring the operating system. The product version operating system may include a variety of additional functions, such as a variety of different second software applications 426 for real-time monitoring system operation data, online seamless update, encryption and decryption module, etc. Therefore, the allocated spaces for the second file system 420 is usually greater than that of the first file system 410. In addition, the factory default operating system is usually used as a backup system, and the integrity must be maintained as much as possible. Therefore, the first file system 410 is mounted in a read-only mode. The product version operating system allows frequent updates, so the second file system 420 is mounted in a read-write mode.

In a further embodiment, the first partition 412 and the second partition 422 are configured to be identical so that they can be backups for each other. In this case, the first operating system image file 414 is the same version as the second operating system image file 424. The capacity of the second file system 420 is the same as that of the first file system 410, and both are mounted in the read-write mode. During operation, when one of the file systems is damaged or the upgrading of the operating system is failed, the board management controller 310 mounts another file system to take over the operation, including recovery of the damaged one.

In a further embodiment, the first file system or the second file system is a Journaling Flash File System (JFFS). On the other hand, the first file system or the second file system may also be an Unsorted Block Image File System (UBIFS).

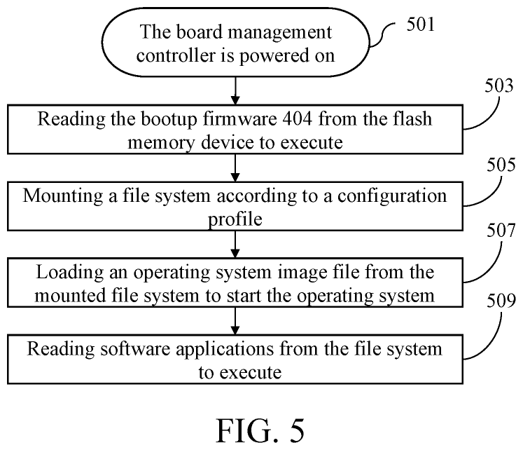

FIG. 5 is a flowchart of starting up the board management controller 310 according to the embodiment of the application. The steps based on the above improved flash memory device 400 architecture are summarized as follows. In step 501, the board management controller 310 is started. In step 503, after the board management controller 310 is powered on or restarted, the microprocessor 320 of the board management controller 310 first reads and executes the bootup firmware 404 from the flash memory device 400 to initialize a kernel, comprising loading a driver for the file system and obtaining a configuration profile for the mount file system. The configuration profile may be a mount table. In step 505, after the board management controller 310 completes the initialization according to the bootup firmware 404, select the mount first file system 410 or the second file system 420 according to the configuration profile. In step 507, the first operating system image file 414 or the second operating system image file 424 is read from the first file system 410 or the second file system 420 being mounted. In step 509, after the first operating system image file 414 or the second operating system image file 424 is successfully executed, read and execute the first software application 416 or the second software application 426 from the first file system 410 or the second file system 420 being mounted.

One of the advantages of the embodiment is the provision of a backup mechanism. When the microprocessor 320 mounts the first file system 410 or the second file system 420, if it is found that the mounted file system is damaged or the operating system image file is damaged, the backup file system may be mounted instead, thereby a backup operating system is loaded to let the board management controller 310 keep functioning. Furthermore, the backup operating system may carry out recover procedures to attempt fix the abnormality in the damaged file system.

Compared with the currently known layout for the flash memory device and startup scheme in the board management controller, the proposed embodiments have multiple obvious advantages.

The board management controller flash memory device of this application has strong flexibility in layout arrangements. In the conventional flash memory device 130, the address offset and size are fixed in advance. Conversely in the embodiment, the operating system is stored as an image file in a file system of flash memory device 400, rather than fixing raw data in physical locations. This way, the partition space can be flexibly utilized to accommodate more files of variable sizes.

The board management controller flash memory device layout of the application has high reliability. The flash memory device is partitioned into two partitions to serve as the file systems. Once a partition is accidentally damaged due to update failure and/or other reasons, another partition may be used to start the board management controller or recover the damaged partition.

The performance of the board management controller adapting the proposed flash memory device layout is improved. The UBIFS has good scalability for flash memory device size, loading time, and memory consumption. The access speed is independent on the partition size, and its performance is significantly better than the JFFS. Adapting the UBIFS in the flash memory device may accelerate the startup performance of the board management controller.

The two partitions used to store the file system in the flash memory device may be of equal size, and the stored contents and read-write attributes may also be adjusted according to the actual situation. For example, both partitions may store the same product version operating system in read-write mode, serving as backups to each other.

It is to be understood that the term “comprises”, “comprising”, or any other variants thereof, is intended to encompass a non-exclusive inclusion, such that a process, method, article, or device of a series of elements not only include those elements but also comprises other elements that are not explicitly listed, or elements that are inherent to such a process, method, article, or device. An element defined by the phrase “comprising a . . . ” does not exclude the presence of the same element in the process, method, article, or device that comprises the element.

Although the present invention has been explained in relation to its preferred embodiment, it does not intend to limit the present invention. It will be apparent to those skilled in the art having regard to this present invention that other modifications of the exemplary embodiments beyond those embodiments specifically described here may be made without departing from the spirit of the invention. Accordingly, such modifications are considered within the scope of the invention as limited solely by the appended claims.

What is claimed is:

1. A board management controller for controlling a computer system, comprising:
a flash memory device, comprising a bootup firmware, a first file system, and a second file system, wherein the first file system stores a first operating system image file and a first software application, and the second file system stores a second operating system image file and a second software application;
a microprocessor connected to the flash memory device; wherein:
when the board management controller is powered on, the microprocessor loads and executes the bootup firmware from the flash memory device;
the microprocessor selectively mounts the first file system or the second file system according to a configuration profile; and
the microprocessor loads and executes an operating system image file and a software application stored in the selectively mounted first or second file system to realize the function of controlling the computer system.

2. The board management controller as claimed in claim 1, wherein:
the flash memory device is partitioned into a boot area, a first area and a second area;
the boot area is located at the foremost portion of the flash memory device and is used to store the bootup firmware;
the first area is formatted as the first file system;
the second area is formatted as the second file system; and
the capacity of the second area is greater than or equal to the capacity of the first area.

3. The board management controller as claimed in claim 1, wherein:
the first operating system image file comprises a first version operating system;
the second operating system image file comprises a second version operating system.

4. The board management controller as claimed in claim 3, wherein:
the first version operating system and the second version operating system are of different versions; and
when the first file system is mounted, the first file system is mounted in a read-only mode; and
when the second file system is mounted, the second file system is mounted in a read-write mode.

5. The board management controller as claimed in claim 3, wherein:
the first version operating system and the second version operating system are of a same version; and
when the first file system or the second file system is mounted, the first file system or the second file system is mounted is mount in a read-write mode.

6. The board management controller as claimed in claim 1, wherein:
the first file system is a flash memory device journal type file system or an unsorted block image file system; and
the second file system is a flash memory device journal type file system or an unsorted block image file system.

7. The board management controller as claimed in claim 1, wherein, when a file system damage is found when the microprocessor mounts one of the first file system and the second file system, the microprocessor mounts another one of the first file system and the second file system not damaged.

8. The board management controller as claimed in claim 7, wherein, after the microprocessor mounts another one of the first file system and the second file system not damaged, the microprocessor executes a recovery program to fix the file system damage.

9. A computer system, comprising a board management controller, controlled by the board management controller to perform at least one of the following functions: startup, shutdown, reset, system firmware upgrade, and operation data monitoring; wherein the board management controller comprises:
a flash memory device, comprising a bootup firmware, a first file system, and a second file system, wherein the first file system stores a first operating system image file and a first software application, and the second file system stores a second operating system image file and a second software application;
a microprocessor connected to the flash memory device; wherein:
when the board management controller is powered on, the microprocessor loads and executes the bootup firmware from the flash memory device;
the microprocessor selectively mounts the first file system or the second file system according to a configuration profile; and
the microprocessor loads and executes an operating system image file and a software application stored in the selectively mounted first or second file system to realize the function of controlling the computer system.

10. A board management controller startup method, adaptable in a board management controller comprising a flash memory device and a microprocessor; wherein the flash memory device comprises a bootup firmware, a first file system, and a second file system, the first file system stores a first operating system image file and a first software application, and the second file system stores a second operating system image file and a second software application; and the board management controller startup method comprising:
loading and executing the bootup firmware from the boot area when the board management controller is powered on;
selectively mounting a first file system or a second file system according to a configuration profile; and
loading and executing an operating system image file and a software application stored in the selectively mounted first or second file system to control a computer system.

11. The board management controller startup method as claimed in claim 10, further comprising: when a file system damage is found while mounting one of the first file system and the second file system, changing to mount another one of the first file system and the second file system.

12. The board management controller startup method as claimed in claim 11, further comprising: after changing to mount another one of the first file system and the second file system, executing a recovery program to fix the file system damage.

13. The board management controller startup method as claimed in claim 10, further comprising:
partitioning the flash memory device into a boot area, a first area and a second area;
utilizing the boot area to store the bootup firmware;
formatting the first area into the first file system; and
formatting the second area into the second file system; wherein:
the boot area is located at the foremost portion of the flash memory device; and
the capacity of the second area is greater than or equal to the capacity of the first area.

14. The board management controller startup method as claimed in claim 10, wherein:
the first operating system image file comprises a first version operating system;
the second operating system image file comprises a second version operating system.

15. The board management controller startup method as claimed in claim 14, wherein the first version operating system and the second version operating system are of different versions; and the board management controller startup method further comprising:
the step of mounting the first file system comprises: mounting the first file system in a read-only mode; and
the step of mounting the second file system comprises: mounting the second file system in a read-write mode.

16. The board management controller startup method as claimed in claim 14, wherein:
the first version operating system and the second version operating system are of a same version;
the step of mounting the first file system comprises: mounting the first file system in a read-write mode; and
the step of mounting the second file system comprises: mounting the second file system in a read-write mode.

17. The board management controller startup method as claimed in claim 10, wherein:
the first file system is a flash memory device journal type file system or an unsorted block image file system; and
the second file system is a flash memory device journal type file system or an unsorted block image file system.
